(19) United States
(12) Patent Application Publication
(10) Pub. No.: US 2007/0031164 A1
(43) Pub. Date: Feb. 8, 2007

(54) Developer Cartridge, Print Process Cartridge, And Image Forming Apparatus

(75) Inventor: Atsushi OTA, Minato-ku, Tokyo (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: OKI DATA CORPORATION, Tokyo (JP)

(21) Appl. No.: 11/458,766

(22) Filed: Jul. 20, 2006

(30) Foreign Application Priority Data
Jul. 21, 2005 (JP) 2005-210808

(51) Int. Cl. G03G 15/08

(52) U.S. Cl. 399/120

(57) ABSTRACT

A developer cartridge holds developer that is supplied into a print process cartridge of an image forming apparatus. The he developer cartridge includes a fresh developer chamber and a waste developer chamber. The fresh developer chamber holds fresh developer in it. The waste developer chamber holds waste developer in it. An inlet is formed in the waste developer chamber. The waste developer is received through the inlet into the waste developer chamber. A first opening-and-closing member opens and closes the inlet. A mechanism drives the first opening-and-closing member to open the inlet when an operating member is positioned to a first position after the developer cartridge is attached to the print process cartridge. The mechanism driving the first opening-and-closing member to close the inlet when the operating member is positioned to a second position before the developer cartridge is detached from the print process cartridge.

### BACKGROUND OF THE INVENTION

1. Field of the Invention

The present invention relates to a developer cartridge, a print process cartridge, and an image forming apparatus.

2. Description of the Related Art

Electrophotographic process is performed in a conventional image forming apparatus such as an electrophotographic printer, a copying machine, or a facsimile machine. A charging unit charges a circumferential surface of an image bearing body. An exposing unit such as a light emitting diode head (LED head) illuminates the charged circumferential surface of the image bearing body to form an electrostatic latent image. A developing unit supplies developer to the electrostatic latent image to develop it with the developer into a developer image. The developer image is transferred onto paper that is being advanced. The paper then enters a fixing unit where the developer image is fixed into a permanent image. Some of the developer may remain on the image bearing body after transfer of the developer image onto the paper. The residual developer is removed by a cleaning blade. A waste developer collecting unit transports the residual developer removed from the image bearing body. The residual developer is finally collected as a waste developer into a developer cartridge.

Such a conventional developer cartridge includes a fresh developer chamber that holds fresh developer to be supplied into a print process cartridge of the image forming apparatus and a waste developer chamber that holds the waste developer. Japanese patent publication (KOKAI) No. 2004-85894 discloses this type of developer cartridge and an image forming apparatus to which the developer cartridge is attached.

FIG. 13A illustrates a generally cylindrical developer cartridge 101 immediately before it is mounted to the print process cartridge 102.

The developer cartridge 101 includes a lid 104 that opens and closes an opening 101a from the inside of the developer cartridge 101, and a spring 104a that urges the lid 104 toward the opening 101a. The spring 104a has one end fixed to an inner wall that defines the opening 101a and another end fixed to the lid 104, and urges the lid 104 against the wall of the developer cartridge to close the opening 101a.

FIG. 13B illustrates the print process cartridge 102 shortly after it is mounted to the print process cartridge 102. The print process cartridge 102 includes a waste developer discharging cylinder 103 to which the developer cartridge 101 is attached. The waste developer is collected into the developer cartridge 101 through the waste developer discharging cylinder 103. The discharging mechanism 103 includes an opening 103a through which the waste developer is discharged into the developer cartridge 101, a lid 105 that fits over the discharging cylinder 103b and is slidable in an axial direction of the discharging cylinder 103b. A spring 105a is mounted to the discharging cylinder 103 and urges the lid 105 toward a free end of the discharging cylinder 103b.

The opening 101a of the developer cartridge 101 is a cylindrical hole having an inner diameter slightly larger than an outer diameter of the discharging cylinder 103b. When the developer cartridge 101 is out of the print process cartridge 102, the lid 104 closes the opening 101a of the developer cartridge 101 and the lid 105 closes the discharges cylinder 103b of the print process cartridge 102. Specifically, the spring 104a urges the lid 104 to close the opening 101a while the spring 105a urges the lid 105 to close the opening in the discharging cylinder 103b, so that the developer held in the developer cartridge 101 and in the discharging cylinder 103b is prevented from leaking out.

Prior to attachment of the developer cartridge to the print process cartridge 102, the developer cartridge 101 is tilted at an angle and is attached to the print process cartridge 102 so that the discharge cylinder 103b enters the opening 101a. Then, a user moves the developer cartridge 101 in a direction shown by arrow P to fit to the print process cartridge 102. At this moment, the side wall of the developer cartridge 101 pushes the lid 105 away from the free end in the axial direction of the discharging cylinder 103b, causing the opening 103a to be exposed. Then, as the user moves the developer cartridge 101 further, the discharging cylinder 103b enters the developer cartridge 101 through the opening 101a. The tip of the discharging cylinder 103b causes the lid 104 to slide into the developer cartridge 101 against the urging force of the spring 104a.

As described above, the developer cartridge 101 is mounted to the print process cartridge 102. As shown in FIG. 13B, as long as the developer cartridge 101 remains attached to the print process cartridge 102, both the opening 101a and the opening 103a remain open. Thus, the waste developer in the discharging cylinder 103b is transported in a direction shown by arrow A (FIG. 13B), and falls into the developer cartridge 101 through the opening 103a. A spiral 106 transports the waste developer toward a far end of the developer cartridge 101.

FIG. 13C illustrates the cylindrical developer cartridge 101 when it is being detached from the print process cartridge 102.

When the developer cartridge 101 is detached from the print process cartridge 102, the developer cartridge 101 is first tilted at an angle with a horizontal direction, and is then pulled in a direction shown by arrow Q in FIG. 13C. When the developing cartridge 101 is pulled farther away from the print process cartridge 102, the urging force of the spring 104a causes the lid 104 to close the opening 101a and opening 103a while the urging force of the spring 105a causes the lid 105 to close the opening 103a.

As described above, the developer cartridge 101 is tilted before it is detached from the print process cartridge 102.

FIGS. 14A and 14B illustrate the conventional developer cartridge 101 when the developer cartridge 101 is taken out of the print process cartridge 102.

Due to the inclination of the developer cartridge 101, the waste developer in the developer cartridge 101 tends to move toward the opening 101a and piles up in the vicinity of the opening 101a. If the waste developer reaches the lid 104, the waste developer will be pushed out of the developer cartridge 101.

### SUMMARY OF THE INVENTION

The present invention was made in view of the aforementioned problem.

An object of the invention is to provide a developer cartridge in which the waste developer will not spill out of the developer cartridge when the developer cartridge is detached from the print process cartridge.

Another object of the invention is to provide a print process cartridge to which the developer cartridge is attached.

Still another object of the invention is to provide an image forming apparatus to which the print process cartridge is attached.

A developer cartridge holds developer. The developer cartridge includes a fresh developer chamber, a waste developer chamber, an inlet, a first opening-and-closing member, and a mechanism. The fresh developer chamber holds fresh developer. The waste developer chamber holds waste developer. The inlet is formed in the waste developer chamber, the waste developer being received through the inlet into the waste developer chamber. The first opening-and-closing member opens and closes the inlet. The mechanism drives the first opening-and-closing member to open the inlet.

The developer cartridge further includes an opening and a second opening-and-closing member. The opening is formed in the fresh developer chamber through which the fresh developer is discharged from the fresh developer chamber. The second opening-and-closing member opens and closes the opening.

The mechanism causes the second opening-and-closing member and the first opening-and-closing member to open and close in an interlocked relation.

The mechanism operates in such a way that the first and second opening-and-closing members close the inlet and the opening, respectively, when the operating member is at a first position, and that the first and second opening-and-closing members open the inlet and the opening, respectively, when the operating member is at a second position.

The mechanism causes the first opening-and-closing member to rotate through an angle about an axis when the mechanism drives the first opening-and-closing member.

The first opening-and-closing member includes a shaft, a gear attached to one end of the shaft, and a cap attached to another end of the shaft, wherein the mechanism transmits a drive force to the gear to drive the first opening-and-closing member in rotation about the shaft.

A print process cartridge forms an electrostatic latent image on an image bearing body and then develops the electrostatic latent image into a developer image. The print process cartridge includes a developer cartridge, a transporting mechanism, and a waste developer discharging port. The developer cartridge includes a fresh developer chamber that holds fresh developer and a waste developer chamber that holds waste developer unit on a recording medium. The transporting mechanism transports waste developer removed from the image bearing body.

The waste developer is supplied from the transporting mechanism into the waste developer chamber through waste developer discharging port. The developer cartridge includes an inlet, an opening-and-closing member, and a mechanism that drives the opening-and-closing member. The inlet is formed in the waste developer chamber, the waste developer being received into the waste developer chamber through the inlet. The opening-and-closing member opens and closes the inlet. The mechanism drives the opening-and-closing member to open and closes the inlet.

An image forming apparatus incorporates the developing apparatus.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limiting the present invention, and wherein:

FIG. 1 is a cross-sectional view of an image forming apparatus according to a first embodiment;

FIG. 2 illustrates one of image forming sections of the image forming apparatus;

FIG. 3 is a perspective view illustrating a print process cartridge;

FIG. 4 is an exploded perspective view of a developer cartridge;

FIG. 5 is a fragmentary perspective view of a side wall;

FIG. 6 is a cross-sectional side view of the developer cartridge;

FIGS. 7A and 7B are cross-sectional views taken along a line X-X′ of FIG. 4;

FIG. 8A illustrates a discharging opening when it is closed;

FIG. 8B illustrates the discharging opening when it is opened;

FIG. 8C is a cross-sectional view taken along a line 8C-8C of FIG. 8D;

FIG. 8D is a cross-sectional view illustrating a cap, an opening in an inlet gate, and a discharging cylinder when the cap closes the opening;

FIG. 8E is a cross-sectional view taken along a line 8E-8E of FIG. 8F;

FIG. 8F is a cross-sectional view illustrating the cap, opening in the inlet gate, and discharging cylinder when the cap closes the opening;

FIGS. 9A and 9B are perspective views illustrating a gear of a lever and another gear of the developer cartridge;

FIG. 10 is a cross sectional view of a side wall that closes one longitudinal end of a developer cartridge according to a second embodiment, illustrating a discharging cylinder and a inlet open/close member;

FIG. 11 is an exploded perspective view as seen from a print process cartridge, illustrating a discharging cylinder, a lid, inlet open/close member, and the side wall;

FIG. 12A is a cross-sectional view taken along a line Y-Y′ of FIG. 10;

FIG. 12B illustrates the discharging cylinder, a short cylinder and a cap when the discharging cylinder is in communication with a waste developer chamber;

FIGS. 13A-13C illustrates a conventional developer cartridge and the print process cartridge that receives the developer cartridge; and

FIGS. 14A and 14B illustrate the conventional developer cartridge and the print process cartridge when the developer cartridge is taken out of the print process cartridge.

### DETAILED DESCRIPTION OF THE INVENTION

Embodiments will be described with reference to the accompanying drawings.

### FIRST EMBODIMENT

{Construction}

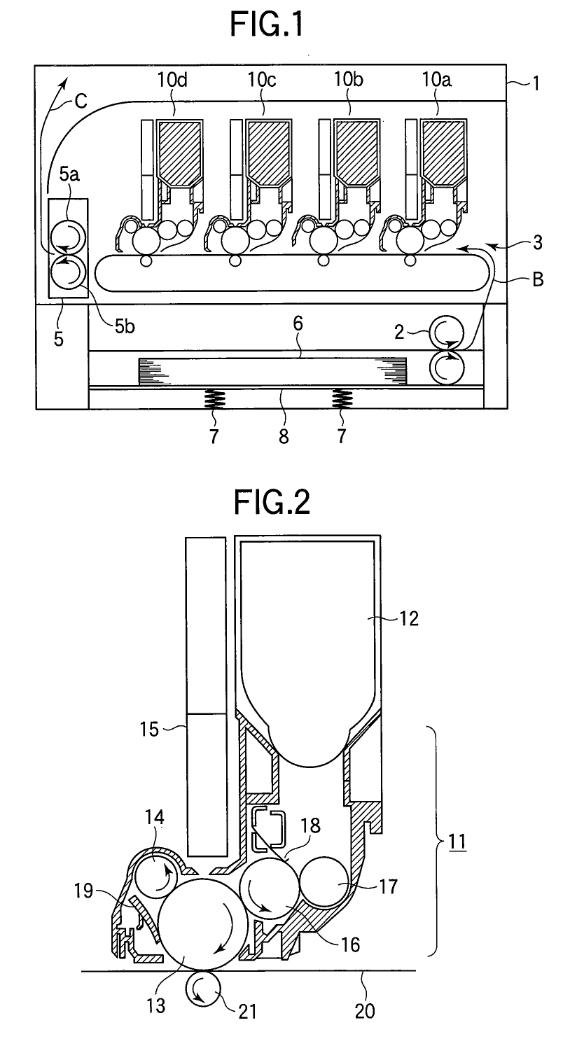

FIG. 1 is a cross-sectional view of an image forming apparatus according to a first embodiment. An image forming apparatus 1 according to the first embodiment is a single-pass type electrophotographic color printer. A paper support platform 7 supports a stack of paper 6 on it. A spring 8 urges the paper support platform 7, so that the top page of the paper 6 is in pressure contact with a hopping roller 2. A transport unit 3 transports each page of the paper 6 in a direction shown by arrow B. A controller, not shown, converts image information received from an external image processing apparatus, not shown, into print information. Image forming sections 10a-10d form developer images of corresponding colors on the paper 6. The developer images of corresponding colors are transferred onto the paper 6 one over the other in registration as the paper 6 advances through the image forming sections 10a-10d. Then, the paper 6 passes through a fixing unit 5 where the developer images are fixed in to a permanent full color image. The paper 6 having the permanent image is then discharged onto a stacker.

The image forming sections 10a-10d are detachably attached to the image forming apparatus 1. The developer is supplied from a fresh developer chamber of a developer cartridge 12 (FIG. 2) and the waste developer is collected into a waste developer chamber of the developer cartridge 12.

The image forming sections 10a, 10b, 10c, and 10d employ an LED type exposing unit, and perform charging, exposing, developing, and transferring to form images of black, yellow, magenta, and cyan, respectively.

FIG. 2 illustrates one of the image forming sections 10a-10d.

Each of the image forming sections 10a-10d includes the developer cartridge 12 and a print process cartridge 11. A charging roller 14 charges a circumferential surface of an image bearing body 13. An exposing unit 15 illuminates the charged surface of the image bearing body 13 to form an electrostatic latent image. A developing roller 16 supplies the developer to the electrostatic latent image formed on the image bearing body 3. A developer supplying roller 17 supplies the developer to the developing roller 16. A developing blade 18 is in pressure contact with the circumferential surface of the developing roller 16, and forms a thin layer of developer when the developing roller 16 rotates. A cleaning device 19 removes residual developer from the circumferential surface of the image bearing body 13 after transfer.

A transfer belt 20 is disposed under the image forming section 10a. A transfer roller 21 is disposed beneath the transfer belt 20. A bias voltage having an opposite polarity to the image bearing body 13 is applied to the transfer roller 21. The transfer belt 20 is a part of the transport unit 3, and runs in sandwiched relation between the image bearing body 13 and the transfer roller 21. The transfer belt 20 is charged by a charging means, not shown, and attracts the paper 6 to transport the paper 6 through the image forming section 10a.

Just before the paper 6 arrives at the image forming section 10a, the exposing unit 15 begins to illuminate the charged surface of the image bearing body 13 to form an electrostatic latent image. The developing section supplies the developer to the electrostatic latent image, thereby forming a developer image. As the paper 6 enters a transfer point defined between the image bearing body 13 and the transfer roller 21, the developer image is transferred onto the paper 6 with the aid of a bias voltage applied to the transfer roller 21. The aforementioned electrophotographic process is performed in each of the image forming sections 10a-10d.

The fixing unit 5 is located downstream of the image forming section 10d, and includes a fixing roller 5a and a pressure roller 5b that cooperate with each other to hold the paper 6 between them and transport through the fixing unit 5. A heater, not shown, heats the fixing roller 5a so that the developer images of the respective colors on the paper 6 are fused by heat and pressure into a permanent full color image. After fixing, the paper 6 is further transported by a transporting mechanism, not shown, in a direction shown by arrow C (FIG. 1) and is discharged onto a stacker defined on top of the image forming apparatus 1.

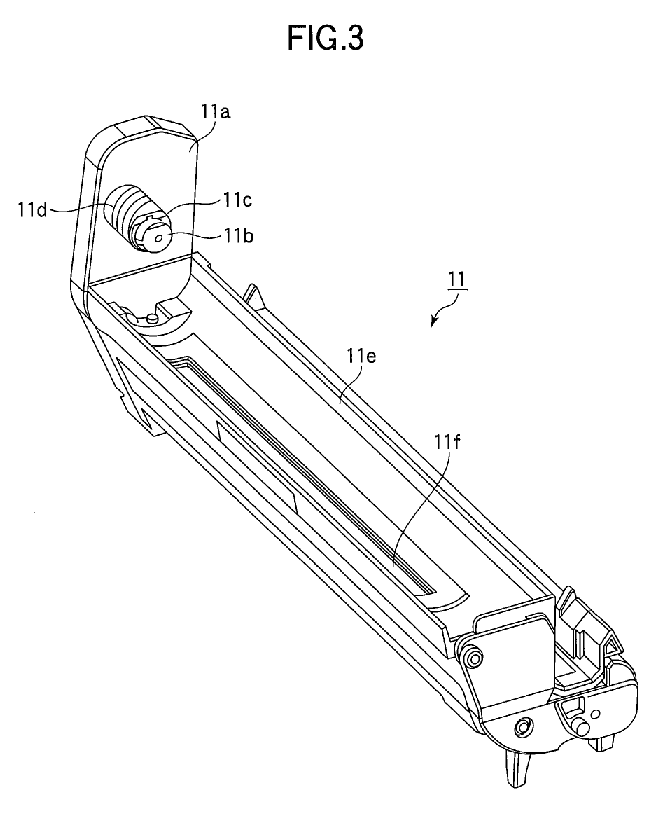

FIG. 3 is a perspective view illustrating the print process cartridge 11.

A transporting section 11a transports the waste developer, and the waste developer is discharged through a discharging cylinder 11b into the developer cartridge 12, not shown. A cylindrical lid 11c fits over the discharging cylinder 11b and is movable along the discharging cylinder 11b to open and close the discharging cylinder 11b. A spring 11d urges the lid 11c away from the transporting section 11a toward a free end of the discharging cylinder 11b. A case lie accommodates the image bearing body 3 and its surroundings in FIG. 2. The fresh developer is supplied into the print process cartridge through an opening 11f. The transporting section 11a transports the waste developer, removed by the cleaning device 19 from the image bearing body 13, into the discharging cylinder 11b. The discharging cylinder 11b has one end fixed to the transporting section 11a. The waste developer is discharged from the transporting section 11a into the discharging cylinder 11b. The lid 11c is provided in the vicinity of a free end of the discharging cylinder 11b, and prevents spillage of the waste developer through an opening, not shown.

A spring 11d fit over the discharging cylinder 11b and extends across the lid 11c and the wall of the transporting section 11a. The spring 11d urges the lid 11c in a direction away from the transporting section 11a, tending to close the opening 11g formed in the discharging cylinder 11b. The case lie accommodates the image bearing body 13, charging roller 14, developing roller 16, toner-supplying roller 17, blade 18, and cleaning device 19. The opening 11f is formed in the top portion of the case 11e. The fresh developer is discharged from the developer cartridge 12 through the opening formed in the developer cartridge 12, and enters the print process cartridge 11 through the opening 11f.

The transporting section 11a of the print process cartridge 11 transports the waste developer, removed by the cleaning device 19, into the middle of the discharging cylinder 11b, thereby feeding the waste developer into a waste developer chamber 30b of the developer cartridge 12.

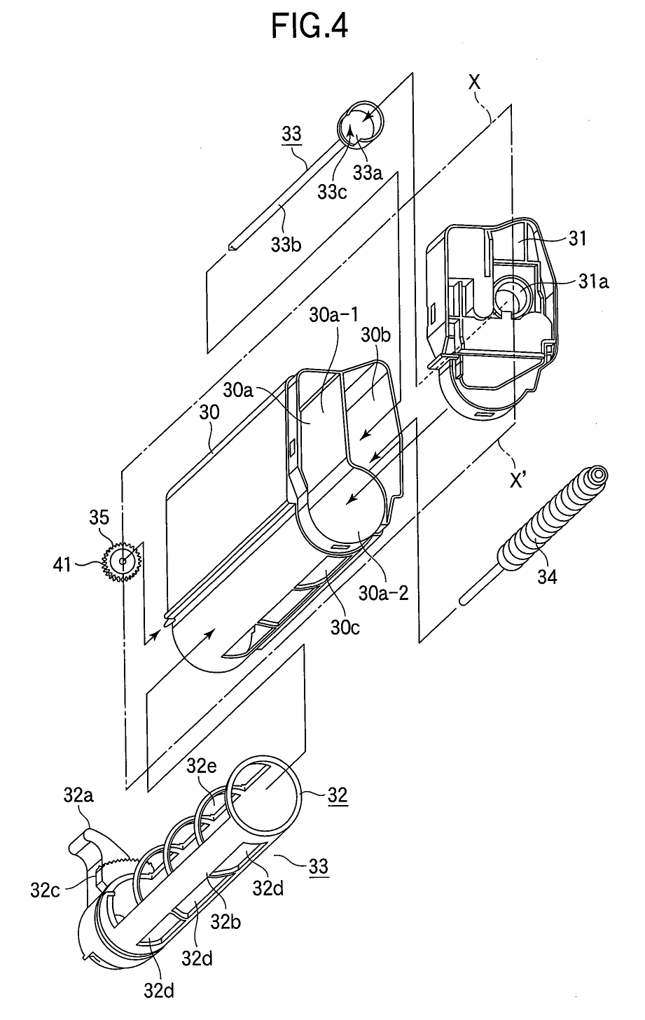

FIG. 4 is an exploded perspective view of the developer cartridge 12.

The developer cartridge 12 is detachably attached to the print process cartridge 11. A body 30 holds the developer in it. A side wall 31 closes one longitudinal end of the body 30. An inlet open/close member 33 is rotatable to open and close an inlet gate 31a formed in the side wall 31. A spiral 34 transports the waste developer in the body 30.

The body 30 includes two sealed chambers: a fresh developing chamber 30a that holds fresh developer and a waste developer chamber 30b that holds waste developer. The fresh developer 30a includes a long box-like upper body 30a-1 and a semi cylindrical lower body 30a-2. The upper body 30a-1 holds a large portion of the fresh developer and the lower body 30a-2 loosely receives the shutter 32. The lower body 30a-2 has a discharging opening 30c formed in its bottom. Specifically, when the developer cartridge 12 is attached into the print process cartridge 11 properly, the developer cartridge 12 can communicate with the print process cartridge 11 through the discharging opening 30c.

The user operates a lever 32a of the shutter 32 to rotate the shutter 32 relative to the semi cylindrical lower body 30a-2, thereby adjusting the amount of the developer supplied into the print process cartridge 11.

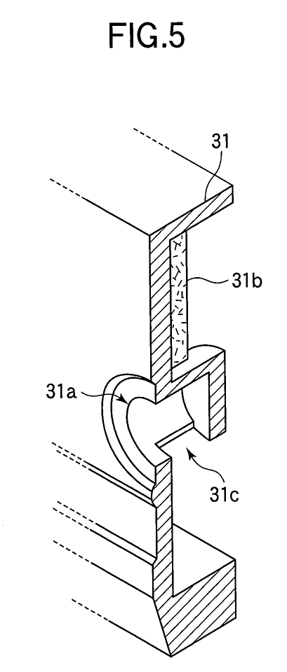

FIG. 5 is a fragmentary perspective view of the side wall 31. The side wall 31 closes one longitudinal end of the body 30, and prevents leakage of the waste developer and fresh developer from their corresponding chambers. Referring to FIG. 5, the side wall 31 has an inlet gate 31a through which the waste developer is received into the waste developer chamber 30b. The inlet gate 31a is a generally cylindrical space one end of which opens to the outer surface of the side wall 31 and another end of which opens to the inner surface of the side wall 31. The another end is closed by a circular bottom plate. The inlet gate 31a has an inner diameter slightly larger than the outer diameter of the discharging cylinder 11b of the print process cartridge 11. The discharging cylinder 11b enters the inlet gate 31a when the developer cartridge 12 is attached to the print process cartridge 11. The inner circumferential wall of the inlet gate 31a is formed with an opening 31c through which the waste developer falls into the waste developer chamber 30b. The opening 31c preferably extends circumferentially through an angle less than 180°. The side wall 31 has a sealing member 31b that seals the gap between the fresh developer chamber 30a and the side wall 31, and the gap between the waste developer chamber 30b and the side wall 31. Another end of the opening 31c can be any shape as long as the waste developer can flow into the waste developer chamber 30b. The another opening of the inlet gate 31a is preferably in such a shape that the waste developer can enter toward the spiral 34.

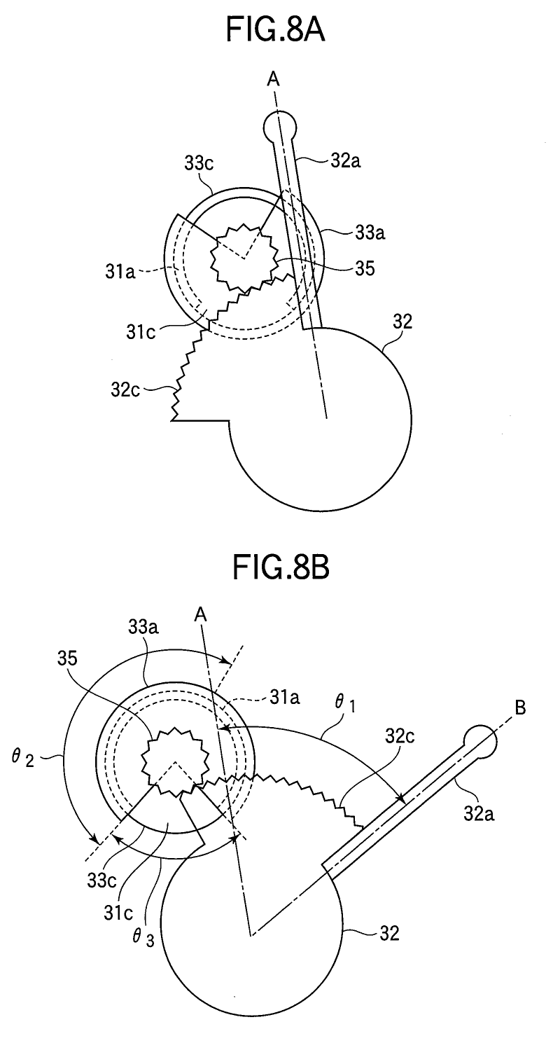

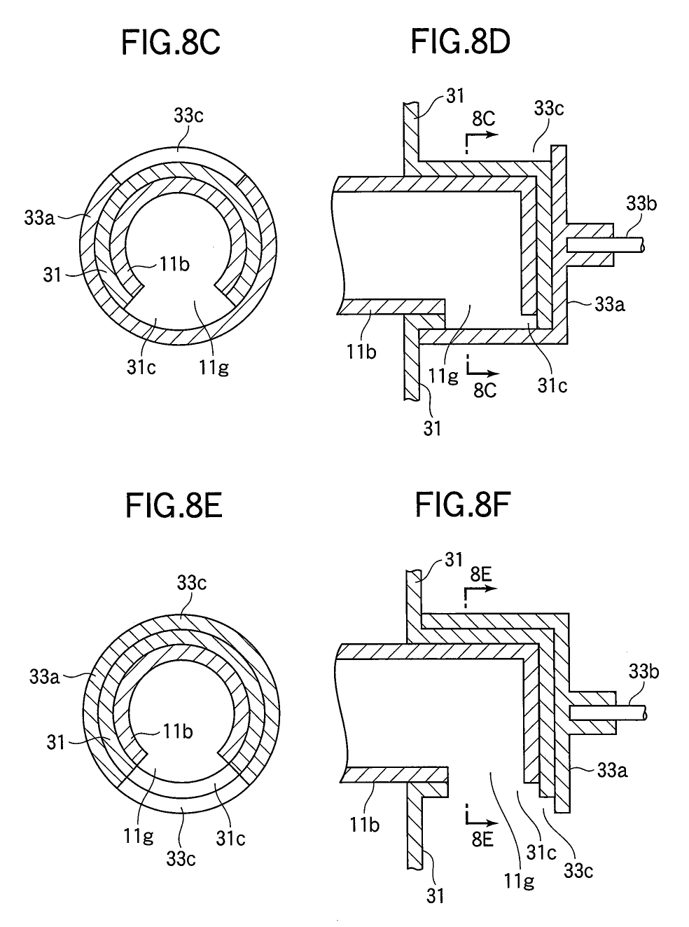

The user operates a lever 32a to adjust the angular position of the shutter 32 relative to the lower body 30a-2 of the developer cartridge 12. The shutter 32 is in one piece construction in its entirety, and has a shape of a cylinder with openings 32e and openings 32d formed therein. The openings 32e are formed such that when the lever 32a is pivoted to an opening position (FIG. 8B), the fresh developer chamber 30a communicates with the print process cartridge 11 through the openings 32e and the openings 32d. A shutter element 32b is formed with a plurality of openings 32d in it. A gear 32c is in mesh with a gear 35, which will be described later. The lever 32a has a projection at its free end portion for the user to operate the shutter 32. When the user causes the lever 32a to pivot about the axis of the shutter element 32b, the angular position of the shutter 32 relative to the lower body 30a-2 is changed. When the shutter 32 is rotated relative to the lower body 30a-2 of the developer chamber 30 to a predetermined angular position, the openings 32d are aligned with the openings 30c so that the box-shaped developer chamber 30a communicates with the print process cartridge 11 of the image forming section. In other words, when the shutter 32 takes up a predetermine angular position, the fresh developer chamber 30a communicates with the print process cartridge 11 through the opening 32e, opening 32d, and opening 30c, so that the fresh developer is discharged from the fresh developer chamber 30a into the print process cartridge 11 through the opening 30c.

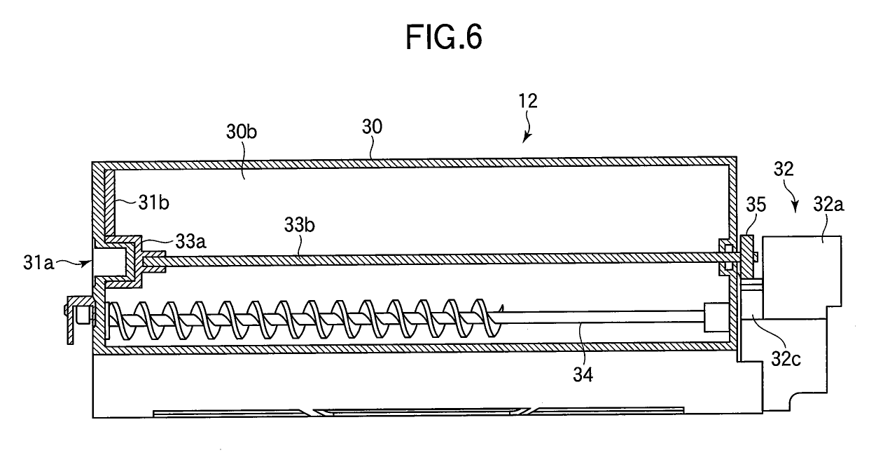

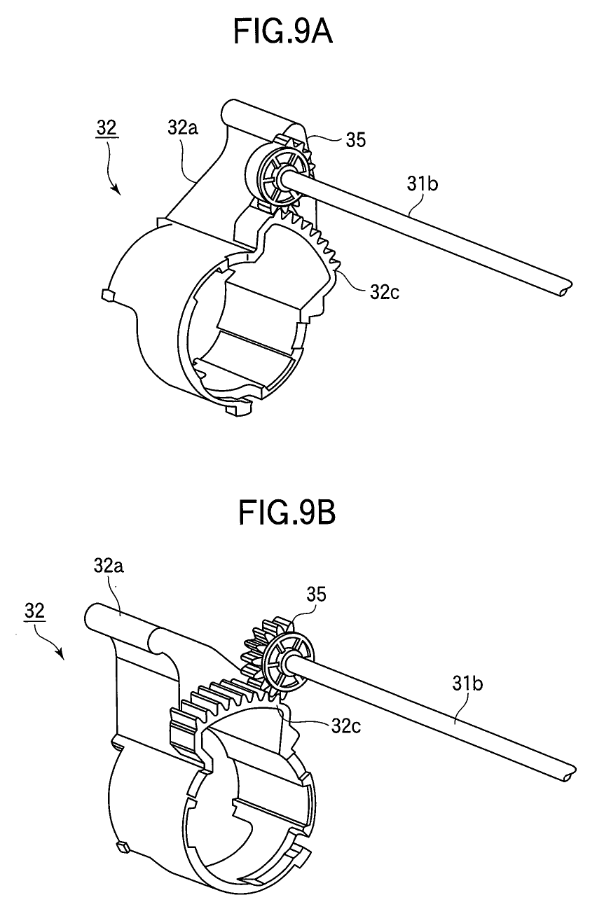

The inlet open/close member 33 includes a cap 33a and a shaft 33b, and is rotatable about the shaft 33b in the waste developer chamber 30b. The cap 33a and the shaft 33b may be either in one piece with each other or separate parts. The cap 33a is in the shape of a short hollow cylinder with its one end closed, and closes one end of the inlet gate 31a from the inside of the waste developer chamber 30b. The cap 33a has a cutout 33c formed in its circumferential wall, the cutout 33c circumferentially extending along a ¼ of the entire circumference. The cutout 33c is to control the flow of the waste developer through the inlet gate 31a. That is, when the cutout 33c overlaps the opening 31c at least partially, the waste developer is allowed to flow into the waste developer chamber 30b through the cutout 33c. When the cutout 33c and the opening 31c are not alignment or not overlapped each other, the waste developer does not flow into the waste developer chamber 30b. The cap 33a has an inner diameter slightly larger than an outer diameter of the inlet gate 31a. The shaft 33b has one end fixed to the center of the circular bottom wall of the cap 33a and another end fixed to the gear 35, and extends through the developer cartridge 12. The cap 33a fits over the inlet gate 31a of the side wall 31. The gear 35 is in mesh with the gear 32c so that when the user operates the lever 32a, the gear 32c causes the gear 35 to rotate (FIG. 9A) FIG. 6 is a cross-sectional side view of the developer cartridge 12.

Referring to FIG. 6, the cap 33a fits over the inlet gate 31a. When the rotation of the shutter 32 is transmitted to the inlet open/close member 33 via the gear 35 and the gear 32c, the cap 33a rotates about the shaft 33b to open or close the opening 31c.

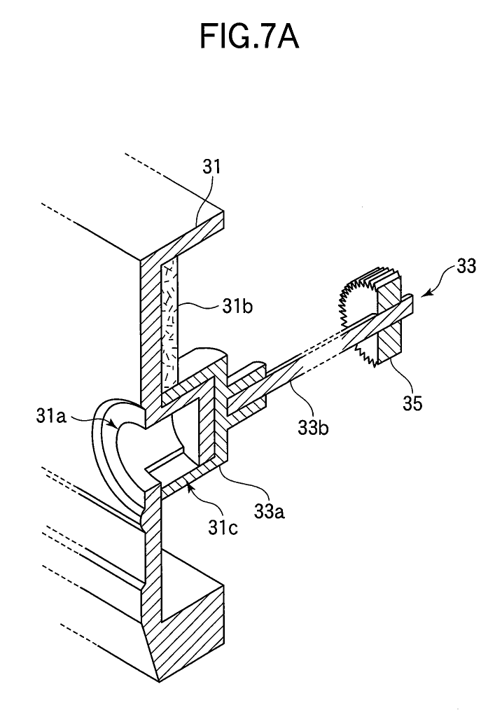

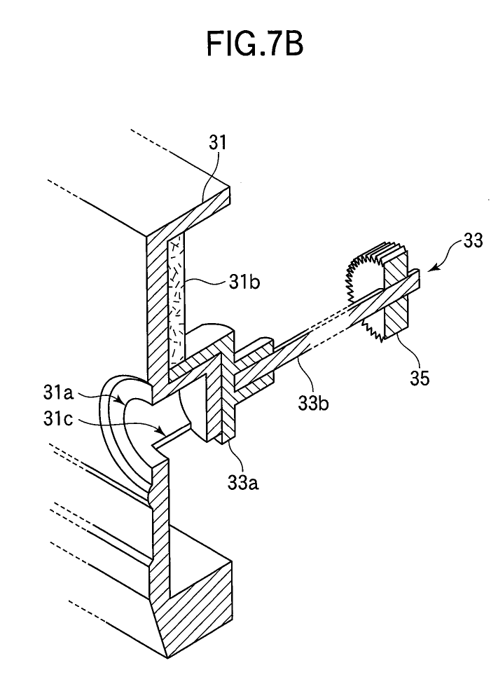

FIGS. 7A and 7B are cross-sectional views taken along a line X-X′ of FIG. 4 illustrating the opening and closing of the opening 31c. The opening 31c is opened when the cutout 33c in the cap 33a and the opening 31c are in alignment with each other or are overlapped each other as shown in FIG. 7A. The opening 31c is not opened when the cutout 33c in the cap 33a and the opening 31c are not in alignment with each other or are not overlapped each other as shown in FIG. 7B. In other words, the user operates the lever 32a to rotate the inlet open/close member 33, thereby opening and closing the opening 31c.

The spiral 34 extends in a longitudinal direction of the waste developer chamber 30b, and transports the waste developer from a near end toward the far end in the waste developer chamber 30b.

{Operation}

FIG. 8A illustrates the positional relation between the cutout 33c in the cap 33a and opening 31c in the inlet gate 31a when the cap 33a closes the opening 31c.

FIG. 8C is a cross-sectional view taken along a line 8C-8C of FIG. 8D.

FIG. 8D is a cross-sectional view illustrating the cap 33a, opening 31c in the inlet gate 31a, and discharging cylinder 11b when the cap 33a closes the opening 31c.

At this moment, the lever 32a is at position A (FIG. 8A) and the cutout 33c oriented upward so that the cap 33a closes opening 31c. The shutter element 32b of the shutter 32 closes the fresh developer chamber 30a.

FIG. 8B illustrates the positional relation between the cutout 33c in the cap 33a and opening 31c in the inlet gate 31a when the cap 33a opens the opening 31c.

FIG. 8E is a cross-sectional view taken along a line 8E-8E of FIG. 8F.

FIG. 8F is a cross-sectional view illustrating the cap 33a, opening 31c in the inlet gate 31a, and discharging cylinder 11b when the cap 33a closes the opening 31c.

Referring to FIG. 8B, the lever 32a has pivoted through an angle θ1 from position A (FIG. 8A) to position B. As the lever 32a is pivoted from position A to position B, the shutter element 32b also rotates so that the openings 32d move into alignment with the discharging opening 30c and the openings 32e move to face the inner space of the fresh developer chamber 30a. The gear 32c also rotates through the angle θ1 causing the gear 35 to rotate so that the cap 33a rotates about the shaft 33b through an angle θ2. The rotation of the cap 33a causes the cutout 33c to face downward so that the cap 33a opens the opening 31c. The number of teeth of the gear 32c and the number of teeth of the gear 35 are related such that θ2=θ1×(Z1/Z2) where Z1 is the number of teeth of the gear 32c for its one complete circumference and Z2 is the number of teeth of the gear 35 for its one complete circumference, and θ2 is the angular rotation of the cutout 33c. This relation ensures that the rotation of inlet open/close member 33 completely closes and opens the discharging opening 31c, and allows the user to know the opening angle θ3 of the opening 31c in terms of the rotation amount of the shutter 32. The angle θ3 is selected to be in the range of θ3<180 and θ3<θ2. The angle θ3 and the size of the discharging opening 30c may be selected as long as the aforementioned opening and closing of the opening 31c is accomplished.

{Example of Gears}

FIGS. 9A and 9B are perspective views illustrating a specific example of the gear 32c of the lever 32a and the gear 35.

It is preferable that each of the gears 32c and 35 has a minimum number of teeth, i.e., as many teeth as the two gears actually mesh each other. Referring to FIGS. 9A and 9B, the gears 32c and 35 are formed with predetermined numbers of teeth such that the aforementioned relation is achieved. Specifically, the number of teeth of the gear 32c is selected to be Z1′=Z1×(θ1/360) . Then, the gears 32c and 35 having such numbers of teeth are manufactured. The gears 32c and gears 35 are brought into meshing engagement with each other such that the cutout 33c is not aligned with the opening 31c when the lever 32a is at position A, and such that the cutout 33c is aligned with the opening 31c when the lever 32a is at position B.

{Attachment of Cartridge}

The developer cartridge 12 of the aforementioned configuration operates as follows.

Before the operator breaks the seal of the package, the lever 32a is at position A in FIG. 8A. In other words, the cutout 33c is oriented upward so that the waste developing chamber 30b is closed completely. Referring to FIG. 3, the user attaches the developer cartridge 12 to the print process cartridge 11 in such a way that the discharging cylinder 11b of the print process cartridge 11 enters the inlet gate 31a of the developer cartridge 12. As the discharging cylinder 11b enters the inlet gate 31a, the lid 11c slides along the discharging cylinder 11b to open a discharging opening 11g (FIG. 8C, FIG. 8E) formed in the discharging cylinder 11b.

Referring back to FIG. 8B, the user rotates the lever 32a through the angle θ1. The rotation of the lever 32a through the angle θ1 causes the shutter 32 to rotate so that the fresh developer chamber 30a communicates with the print process cartridge 11 through the opening 32d and opening 32e. As a result, the fresh developer flows from the fresh developer chamber 30a into the print process cartridge 11. At this moment, the rotation of the gear 35 causes the shaft 33b and the cap 33a to rotate so that the cutout 33c rotates through the angle θ2 to the position in FIG. 8B, opening the opening 31c. This causes the discharging cylinder 11b to communicate with the waste developer chamber 30b through the opening 31c, allowing the waste developer to fall into the waste developer chamber 30b.

{Detachment of Cartridge}

A description will now be given of the operation in which the user detaches the developer cartridge 12 from the print process cartridge. First, the user rotates the lever 32a through the angle θ1 from position B in FIG. 8B back to the original position A in FIG. 8A. The pivotal movement of the lever 32a through the angle θ1 causes the cap 33a to rotate, the cutout 33c being oriented upward so that the fresh developer chamber 30a no longer communicates with the print process cartridge 11 through the openings 32d, 32e, and 30c. The rotation of the lever 32a causes the shaft 33b and the cap 33a to rotate so that the cutout 33c is oriented upward. Thus, the upward orientation of the cutout closes the opening 31c, so that the waste developer chamber 30b no longer communicates with the discharging cylinder 11b. Then, the user tilts the developer cartridge 12 at an angle and draws the developer cartridge 12 from the discharging cylinder 11b of the print process cartridge 11.

Because the waste developer chamber 30b is completely closed before it is taken out from the print process cartridge 11, spillage of the waste developer is prevented. Specifically, operating the lever 32a in one direction allows the fresh developer to flow from the fresh developer chamber into the print process cartridge 11, and operating the lever 32a in the opposite direction causes the opening 31c of the waste developer 30a 30b to close. This operation prevents spillage of the waste developer from the developer cartridge 12 without imposing complicated operation on the user when the developer cartridge 12 is taken out of the print process cartridge 11.

### SECOND EMBODIMENT

An image forming apparatus 40 according to a second embodiment has the same configuration as that according to the first embodiment. Elements similar to those in the first embodiment have been given the same reference numerals and the description of the same elements and configuration as the first embodiment is omitted. Therefore, a description will be given of the configuration different from that of the first embodiment.

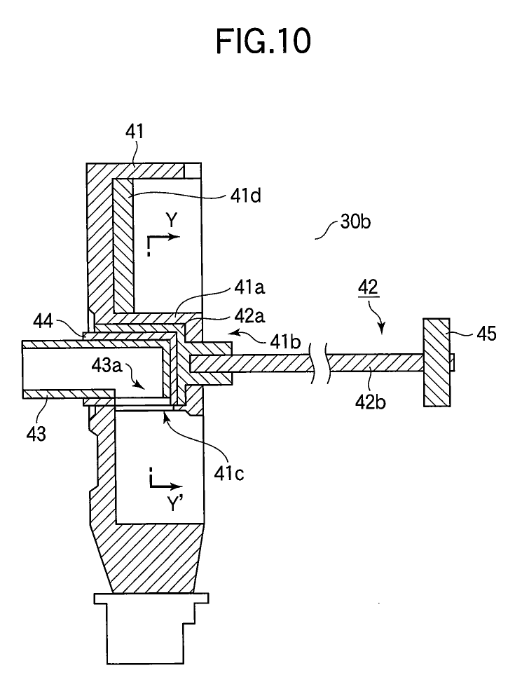

FIG. 10 is a cross sectional view of a sidewall 41 that closes one longitudinal end of a developer cartridge 12 according to the second embodiment, illustrating a discharging cylinder 43 and a cap 42a.

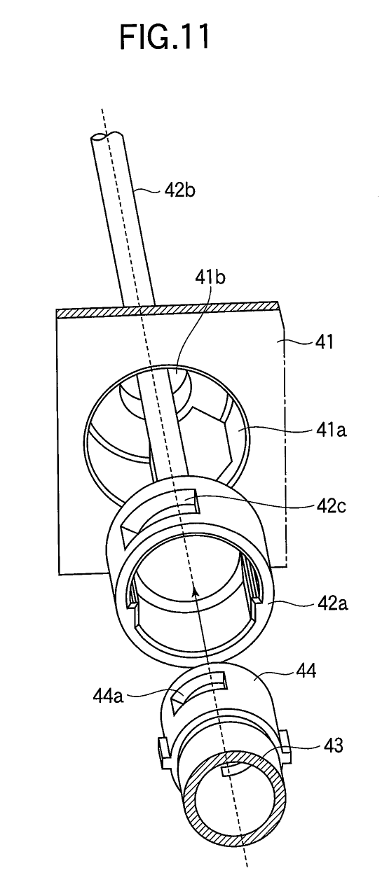

FIG. 11 is an exploded perspective view as seen from a print process cartridge 11, illustrating the discharging cylinder 43, a cylindrical lid 44, an inlet open/close member 42, and the side wall 41.

Referring to FIG. 10, the side wall 41 includes a cylindrical recess 41a having a circumferential wall in which an opening 41b is formed. The side wall 41 is attached to one longitudinal end of the developer cartridge 12 with a sealing member 41d sandwiched between the developer cartridge 12 and the side wall 41. The sealing member 41d provides a sealing between the side wall 41 and the fresh developer chamber, not shown and a sealing between the side wall 41 and the waste developer chamber 30b. The cylindrical recess 41a receives the cap 42a in the shape of a short hollow cylinder with its one end closed. The cap 42a loosely fits into the cylindrical recess 41a and extends through the opening 41b into the interior of the waste developer chamber 30b. The cap 42a has a cutout 41c formed in its circumferential wall of the cap 42a, the cutout 41c circumferentially extending along a ¼ of the entire circumference. A discharging cylinder 43 of the print process cartridge 11 is closed at its one end and has an opening 43a formed in its circumferential wall in the vicinity of the closed end. Another short cylinder 44 has an opening 44a formed in its circumferential wall. The cylinder 44 fits over the discharging cylinder 43, and fittingly enters the cylindrical space of the cap 42a. The cylindrical recess 41a has an opening 41c formed in its circumferential inner surface into which waste developer flows from the discharging cylinder 43.

The inlet open/close member 42 includes the cap 42a and a shaft 42b, and extends across the length of the waste developer chamber 30b. The inlet open/close member 42 is rotatable about the shaft 42b. The cap 42a and the shaft 42b may be either in one piece with each other or separate parts. The cap 42a is in the shape of a short hollow cylinder with its one end closed. The cap 42a has a cutout 42c formed in its circumferential wall, the cutout 42c circumferentially extending along a ¼ of the entire circumference. The cutout 42c is to restrict the flow of the waste developer through the inlet gate 43 into the waste developer chamber 30b. When the inlet open/close member 42 rotates so that the cutout 42c and the opening 43a are aligned with each other or are overlapped each other, the waste developer is introduced into the waste developer chamber 30b.

When the inlet open/close member 42 rotates so that the cutout 42c and the opening 43a are not aligned or are not overlapped each other, the waste developer is not introduced into the waste developer chamber 30b. The cap 42a has an outer diameter slightly smaller than an inner diameter of the cylindrical recess 41a. The cap 42a has an inner diameter slightly larger than an outer diameter of the short cylinder 44. The shaft 42b has one end fixed to the center of the cap 42a and another end fixed to the center of a gear 45 that drives the inlet open/close member 42 in rotation from outside of the developer cartridge 12.

The discharging cylinder 43 is a hollow cylinder through which the waste developer is supplied from the print process cartridge 11, not shown, into the waste developer chamber 30b of the developer cartridge 12.

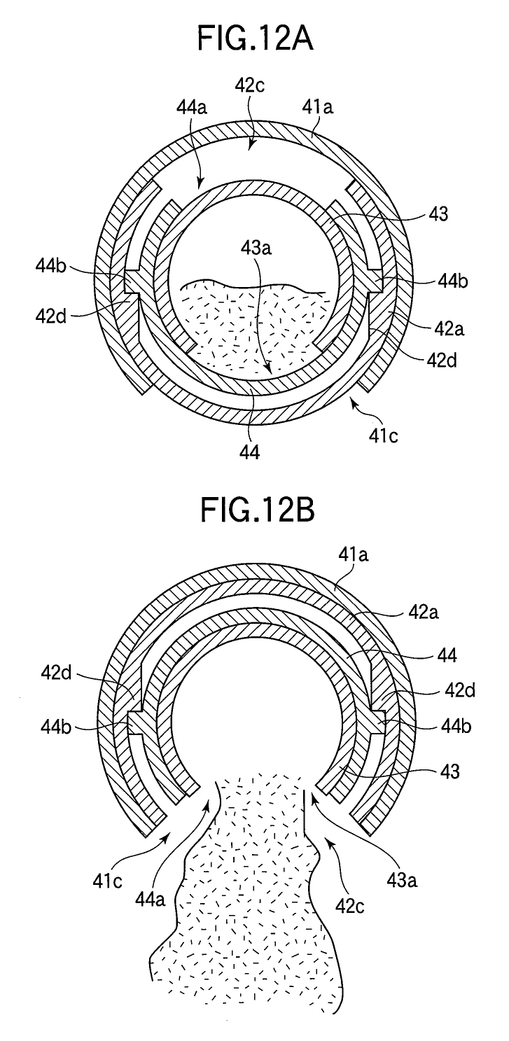

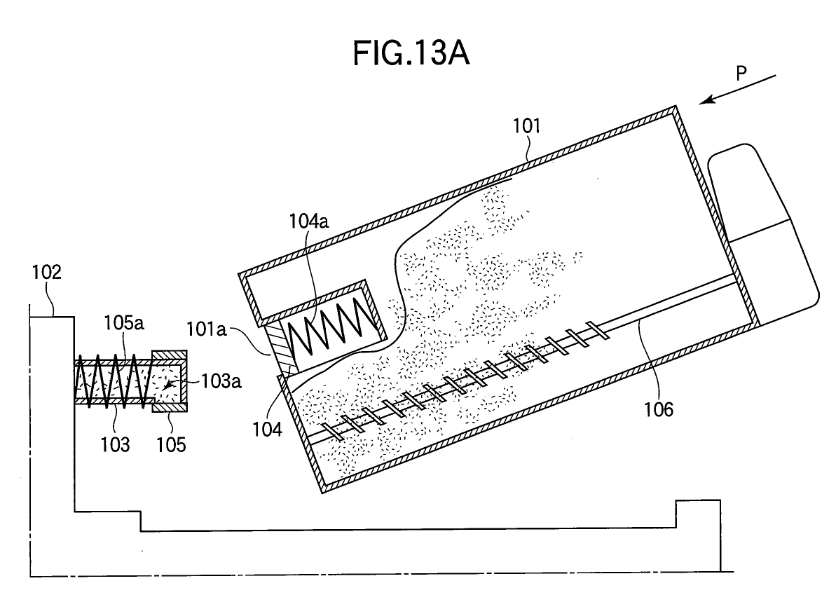

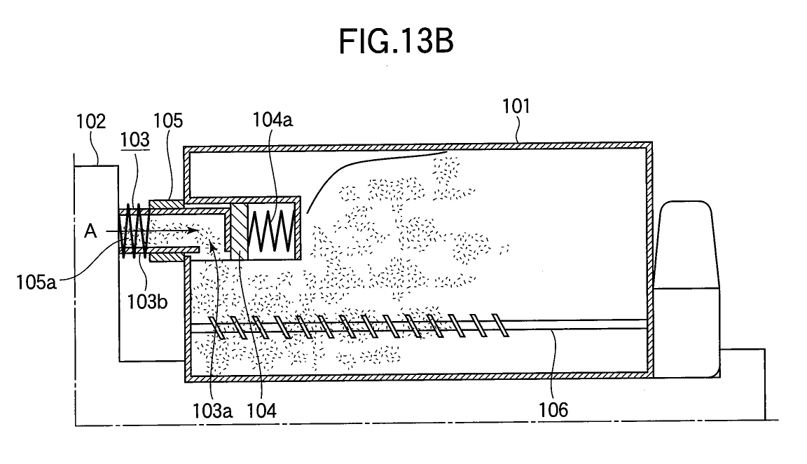

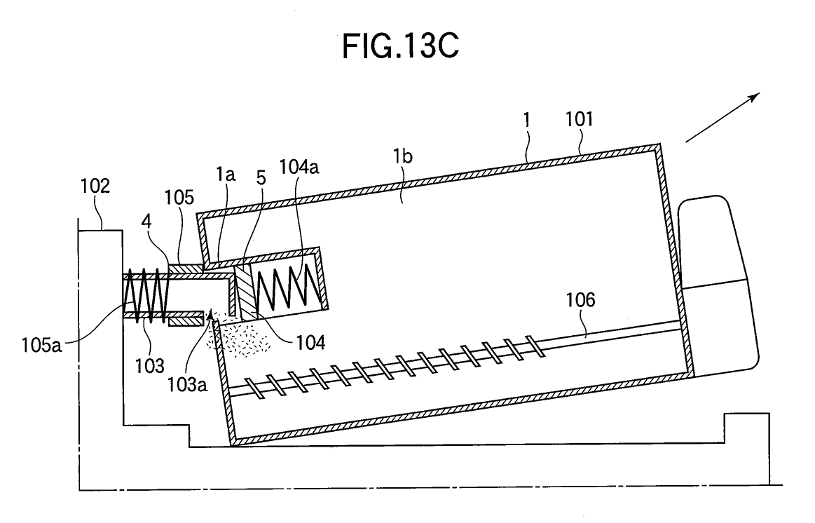

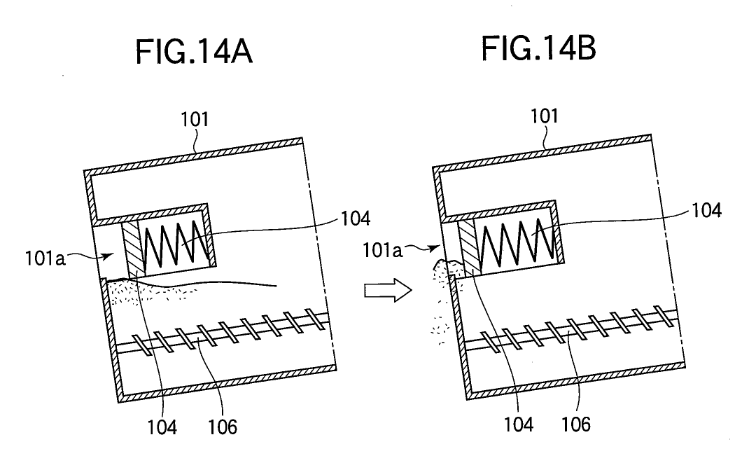

FIG. 12A is a cross-sectional view illustrating the discharging cylinder 43, short cylinder 44, and cap 42a when the discharging cylinder 43 is not in communication with the waste developer chamber 30b.

When the discharging cylinder 43 and short cylinder 44 enter the cylindrical recess 41a, the short cylinder 44 is closing the opening 43a. The short cylinder 44 includes diametrically opposite projections 44b that engage the abutments 42d formed on the inner surface of the cap 42a.

FIG. 12B is a cross sectional view taken along a line Y-Y′ of FIG. 10 illustrating the discharging cylinder 43, short cylinder 44, and cap 42a when the discharging cylinder 43 is in communication with the waste developer chamber 30b.

When a user operates a shutter, not shown, to pivot from a closing position to an opening position, the inlet open/close member 42 rotates so that the cap 42a and the short cylinder 44 rotate together from the position in FIG. 12A to the position in FIG. 12B. Referring to FIG. 12B, the cutout 42c, opening 44a, and cutout 41c are aligned with the opening 43a so that the waste developer is introduced into the waste developer chamber 30b. By using the same procedure as the first embodiment, the fresh developer may be discharged from the fresh developer chamber into the print process cartridge 11 and the waste developer may be received from the print process cartridge 11 into the waste developer chamber 30b.

The engagement of the projections 44b with the abutments 42d eliminates a spring that urges the short cylinder 44.

The invention being thus described, it will be obvious that the same may be varied in many ways. Such variations are not to be regarded as a departure from the spirit and scope of the invention, and all such modifications as would be obvious to one skilled in the art intended to be included within the scope of the following claims.

What is claimed is:

1. A developer cartridge that holds developer, the developer cartridge comprising:
a fresh developer chamber that holds fresh developer;
a waste developer chamber that holds waste developer;
an inlet formed in said waste developer chamber, the waste developer being received through said inlet into said waste developer chamber;
a first opening-and-closing member that opens and closes said inlet; and
a mechanism that drives said first opening-and-closing member to open and close said inlet.

2. The developer cartridge according to claim 1 further comprising:
an opening formed in the fresh developer chamber through which the fresh developer is discharged from the fresh developer chamber; and
a second opening-and-closing member that opens and closes said opening.

3. The developer cartridge according to claim 2, wherein said mechanism causes said second opening-and-closing member and said first opening-and-closing member to open and close in an interlocked relation.

4. The developer cartridge according to claim 1 further comprising an operating member operated by a user;
wherein said mechanism operates in such a way that said first and second opening-and-closing members close said inlet and said opening, respectively, when said operating member is at a first position, and that said first and second opening-and-closing members open said inlet and said opening, respectively, when said operating member is at a second position.

5. The developer cartridge according to claim 1, wherein said mechanism causes said first opening-and-closing member to rotate through an angle about an axis when said mechanism drives said first opening-and-closing member.

6. The developer cartridge according to claim 5, wherein said first opening-and-closing member includes a shaft, a gear attached to one end of the shaft, and a cap attached to another end of the shaft, wherein said mechanism transmits a drive force to the gear to drive said first opening-and-closing member in rotation about the shaft.

7. A print process cartridge that forms an electrostatic latent image on an image bearing body and then develops the electrostatic latent image into a developer image, the print process cartridge comprising:
a developer cartridge including a fresh developer chamber that holds fresh developer and a waste developer chamber that holds waste developer;
a transporting mechanism that transports waste developer removed from the image bearing body;
a waste developer discharging port through which the waste developer is supplied from said transporting mechanism into the waste developer chamber;
wherein said developer cartridge comprises:
an inlet formed in the waste developer chamber, the waste developer being received into the waste developer chamber through said inlet;
an opening-and-closing member that opens and closes said inlet;
a mechanism that drives said opening-and-closing member to open and closes said inlet.

8. An image forming apparatus that incorporating the print process cartridge according to claim 7.
